(19) United States
(12) Patent Application Publication
(10) Pub. No.: US 2026/0340969 A1
(43) Pub. Date: Oct. 29, 2026

(54) METHOD FOR DISPLAYING CONTENT ACCESSIBLE TO SCREEN READERS

(71) Applicant: Be More Colorful, LLC, Fargo, ND (US)

(72) Inventor: Matthew Chaussee, Fargo, ND (US)

(73) Assignee: Be More Colorful, LLC, Fargo, ND (US)

(21) Appl. No.: 19/736,687

(22) Filed: Jul. 9, 2026

Related U.S. Application Data
(63) Continuation-in-part of application No. 18/632,125, filed on Apr. 10, 2024.
(60) Provisional application No. 63/495,371, filed on Apr. 11, 2023.

(51) Int. Cl. G06T 19/20; G06T 15/04

(52) U.S. Cl. CPC G06T 19/20; G06T 15/04; G06T 2219/2004

(57) ABSTRACT

A method for displaying content accessible to screen readers.

### CROSS-REFERENCE TO RELATED APPLICATIONS

This application claims the priority as a continuation-in-part of U.S. Nonprovisional patent application Ser. No. 18/632,125(02211 -BEM) filed Apr. 10, 2024 which claims priority to U.S. Provisional Patent Disclosure Ser. No. 63/495,371 filed Apr. 11, 2023.

Each of the aforementioned patent applications, and any applications related thereto, are herein incorporated by reference in their entirety.

### BACKGROUND

The present disclosure relates to a method for displaying content accessible to screen readers.

Digital cameras with 360-degree capabilities have been used for both taking still photos and videos. The 360-degree photos and videos are created using a combination of multiple panoramic images, photospheric images, or videos captured using an omnidirectional camera. These images are then stitched together to form a contiguous spherical or semispherical image orthogonally positioned to an interactive viewport within a user interface.

Virtual reality, augmented reality, interactive displays, are various examples of immersive environments. Images taken in a 360-degree format require additional processing to place into a format that provides immersive environments. Immersive environments may be used in educational settings; however, such immersive environments are not compatible with visual screen readers which assist the visually impaired by audibly reading text on a screen.

### BRIEF DESCRIPTION OF DRAWINGS

Various features will become apparent to those skilled in the art from the following detailed description of the disclosed non-limiting embodiment. The drawings that accompany the detailed description can be briefly described as follows:

FIG. 1 is a schematic block diagram of a method for displaying content in a way that is accessible to screen readers according to one disclosed non-limiting embodiment.

FIG. 2 is an example equirectangular image upon which the method may be performed.

FIG. 3 is an example three-dimensional spherical geometry configured to support equirectangular image mapping.

FIG. 4 is a schematic view of the equirectangular image rendered onto the surface of three-dimensional spherical geometry.

FIG. 5 is an inner view of a portion of the surface of three-dimensional spherical geometry of FIG. 4.

FIG. 6 is the inner view of FIG. 5 with an example interactive element (hotspots; “!”) positioned thereon.

FIG. 7 is a representation of the transformation of the spherical geometry into cube geometry.

FIG. 8 is a representation of the cube geometry.

FIG. 9 is a representation of the cube geometry of FIG. 8 unwrapped into a horizontal cross shape image.

FIG. 10 is a representation of example interactive element (hotspots; “!”) within the three-dimensional spacial representation.

FIG. 11 is a representation of the horizontal cross shape image with example interactive element (hotspots; “!”) positioned thereon.

### SUMMARY

A method for displaying content accessible to screen readers according to one disclosed non-limiting embodiment of the present disclosure includes rendering an equirectangular image onto a surface of the spherical geometry; creating an immersive visual representation when viewed from the interior of the spherical geometry; positioning an interactive element on the surface of the spherical geometry based on spherical coordinates corresponding to directional vectors relative to a viewing origin; transforming the spherical geometry into cube geometry; and rendering the cube geometry to a cube map texture layout.

A further embodiment of any of the foregoing embodiments of the present disclosure includes, wherein the cube map texture layout is a horizontal cross image.

A further embodiment of any of the foregoing embodiments of the present disclosure includes, wherein transforming the spherical geometry into the cube geometry comprises simultaneously reprojecting the equirectangular texture into a cube map orientation.

A further embodiment of any of the foregoing embodiments of the present disclosure includes adding html elements onto each separate image of the cross image.

A further embodiment of any of the foregoing embodiments of the present disclosure includes, wherein rendering the cube geometry to the cube map texture layout comprises rendering the interactive element aligned to an intended positions on the transformed surface, each interactive element corresponding to a spatial orientation within the three-dimensional environment.

A further embodiment of any of the foregoing embodiments of the present disclosure includes, wherein within the three-dimensional environment comprises at least a front, back, left, right, above, and below relative to the viewing origin.

A further embodiment of any of the foregoing embodiments of the present disclosure includes generating an output subsequent to the rendering the cube geometry to the cube map texture layout, wherein the output comprising a 2D document object model (DOM)-navigable version of the scene intended for non-visual access.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### DETAILED DESCRIPTION

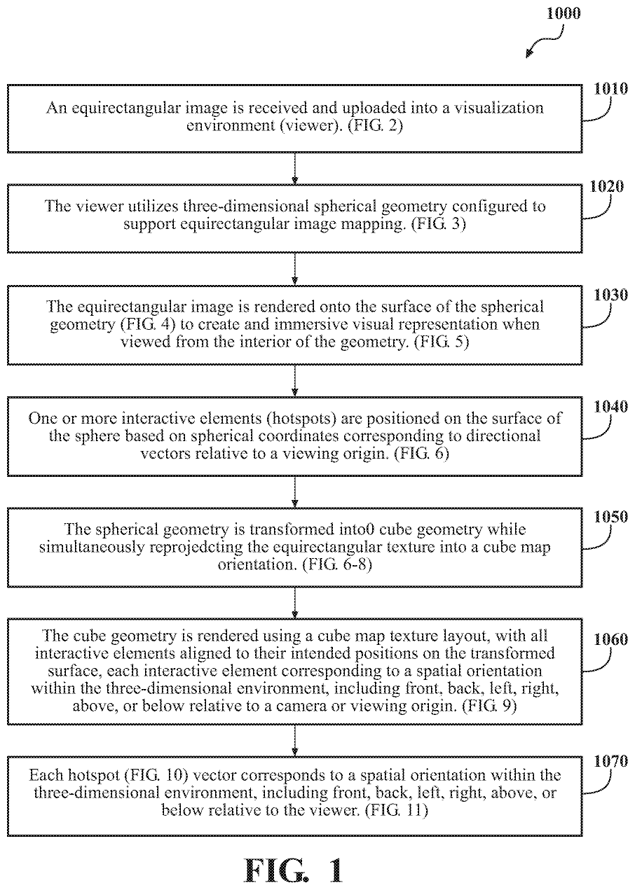

FIG. 1 schematically illustrates a method 1000 for displaying content in a way that is accessible to screen readers.

A viewer in this context is a piece of WebXR software that allows an individual to view and interact with a 360-degree image in various projections (spherical, cube, flat). A Screen Reader is a piece of assistive technology that allows people with low vision to understand what is on the screen in front of them. Screen readers do well with HTML elements but are typically not compatible with WebXR environments. In an HTML environment, a screen reader works by identifying and audibly “reading” text, alt text, image descriptions, and descriptive tags on page elements that exist on fixed locations on a page. A screen reader can only “read” elements that are displayed by the viewer. In WebXR, if elements are not visible, they do not exist within the viewer until the viewing angle is changed. For example, a screen reader cannot inherently see what is behind you on a spherical image because it is not in “view” of the viewer software. The method 1000 ensures all of the spherical image and related interactive hotspot elements are displayed by the viewer in a single non-interactive format, so that all screen readers can access all elements, just like they would on an HTML webpage.

The method 1000 is disclosed in terms of functional block diagrams. It should be appreciated that these functions may be enacted in either dedicated hardware circuitry or programmed software routines capable of execution in various microprocessor-based electronics control embodiments.

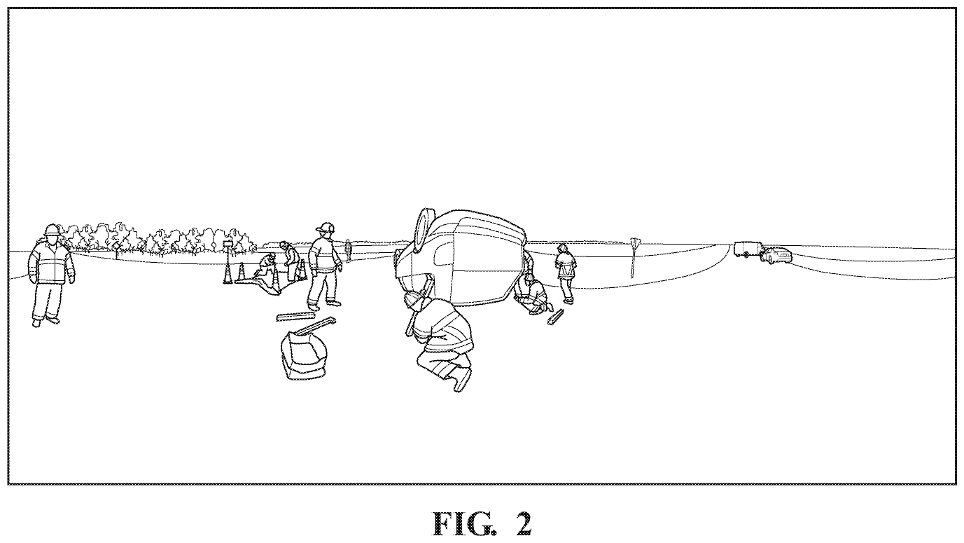

Initially, an equirectangular image is received and uploaded into a visualization environment (e.g., viewer) (1010; FIG. 2). The type of camera which could be used for the disclosed method may include any 360-degree photo and video capture device. Typically, such a device is a single device with multiple lenses allowing for everything from the camera's perspective to be captured. Alternatively, a single device may be panned around manually or automatically to capture the 360-degree image. A 360-degree video capture device may be used to also shoot the 360-degree photo. A video capture device may perform the recording. For example, the video capture device may simultaneously both shoot and record images. A still-frame photo may alternatively or additionally be taken from the 360-degree video.

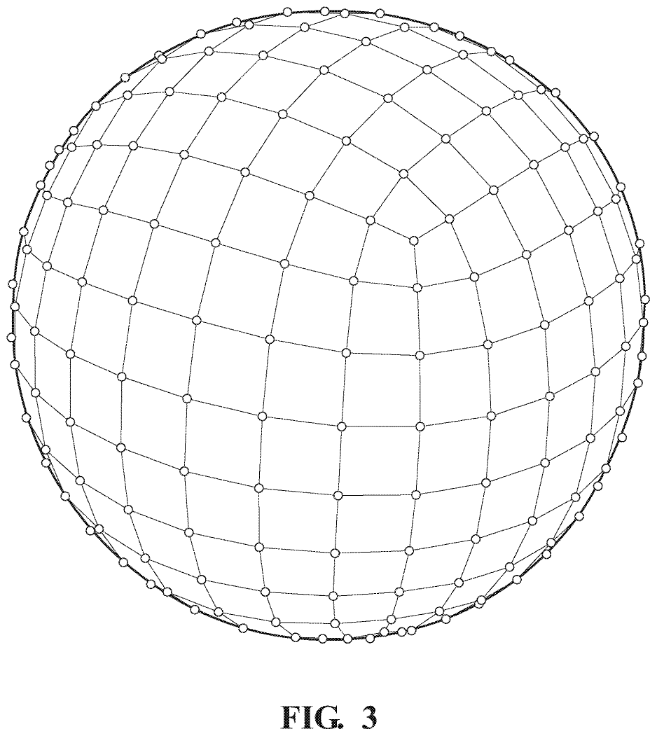

The viewer utilizes the three-dimensional spherical geometry configured to support equirectangular image mapping (1020; FIG. 3). In embodiments, the viewer takes a 2D equirectangular image and maps it onto the surface of a 3D sphere within a WebXR environment. The viewer renders the sphere and takes the flat image file, placing it onto the sphere, wrapping and stretching/compressing the image to fit the spherical geometry (e.g., like a flat map of the earth being mapped onto the globe).

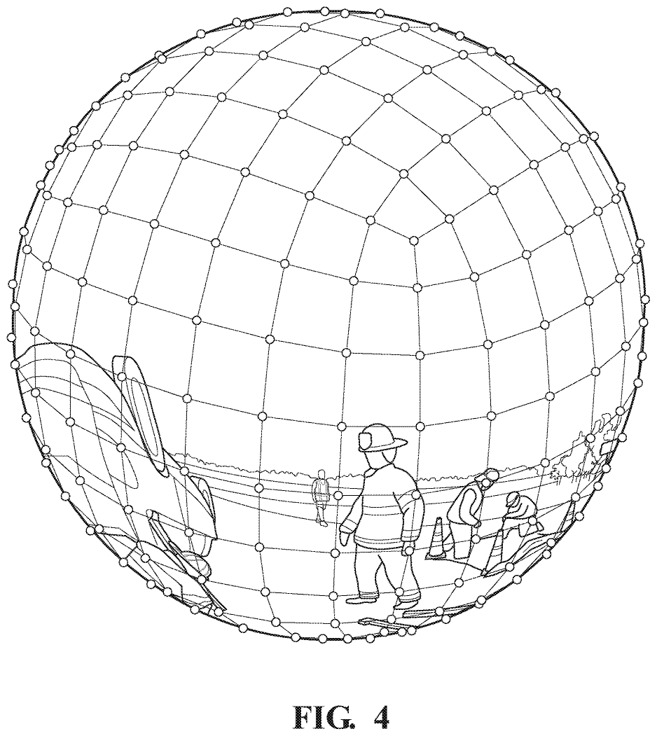

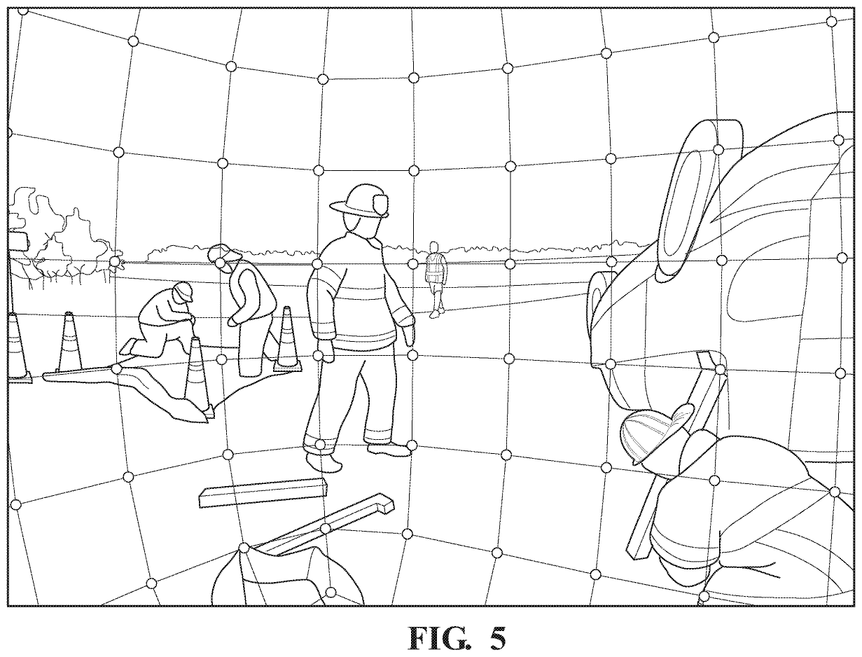

The equirectangular image is rendered onto the surface of the three-dimensional spherical geometry (1030; FIG. 4) to create an immersive visual representation when viewed from the interior of the geometry (FIG. 5; e.g., in the globe example above, except that instead of viewing the globe from the outside, the user is on the inside of the globe lookout out to the image mapped onto the surface).

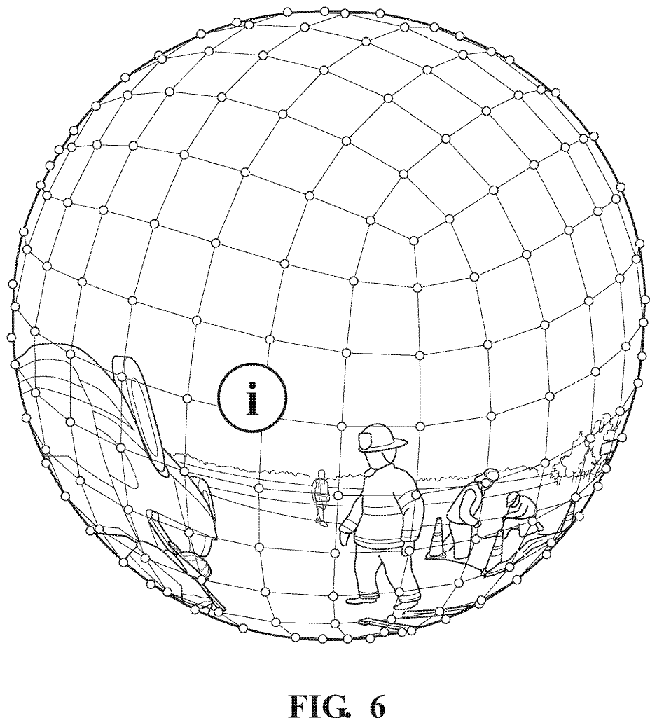

One or more interactive elements (hotspots; “!”) are positioned on the surface of the sphere based on spherical coordinates corresponding to directional vectors relative to a viewing origin (1040; FIG. 6). A hotspot or point of interest is a selectable space of content in the interactive environment. The point of interest is at a location that will be accessed by the viewers in the interactive environment.

A frame of action may provide a pop-out window or content beyond the point of interest. The frame of action may provide text, images, videos, or allows the viewer to learn more about a given part of the interactive environment. A frame of action may be used to provide more information about content communicated in the interactive environment. For example, additional information on the day-to-day items, tools, machinery, or environment a worker is inhabiting may be provided. For example, suppose the method to use a camera is configured for the purpose of providing a career experience to a viewer. In that case, the hotspots may help strengthen the viewer's understanding of what the job environment provides and what prerequisites the viewer may need to succeed in a given career field. The hotspots may also help build the environment with facts about the location, the company, and the developments or practices a company may value. The operator may determine the hotspots.

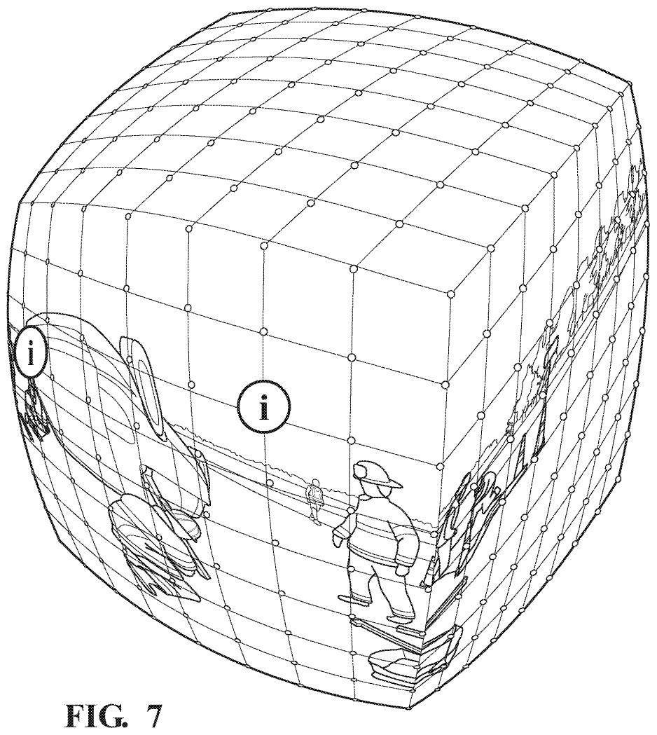

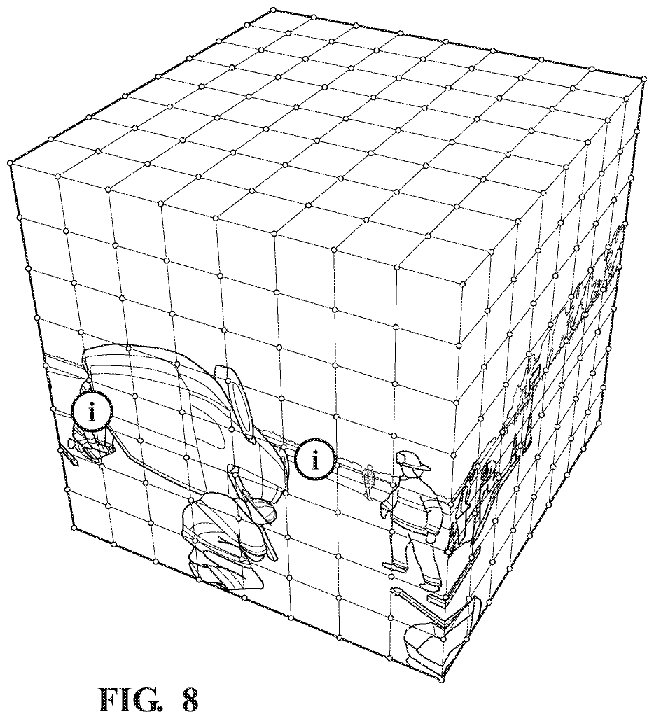

The spherical geometry (FIG. 6) is transformed (FIG. 7) into cube geometry (FIG. 8) while simultaneously reprojecting the equirectangular texture into a cube map orientation (1050). The transformation may be performed through a well-known method called the Quadrilateralized Spherical Cube, where a sphere is inscribed into a cube, and one cube face (for example, “front”) is chosen as a projection target, to fix the sphere's position within the cube, centered on a fixed reference point on the sphere. All other cube faces are mapped with a curvilinear projection, ensuring each cube face “receives” and equal amount of surface area from the sphere, converting latitude, longitude coordinates to x, y coordinates on each cube face.

During this transformation, the positions of the interactive elements are recalculated based on their corresponding directional vectors, such that visual continuity of the image is preserved, and each element maintains its correct relative location within the scene.

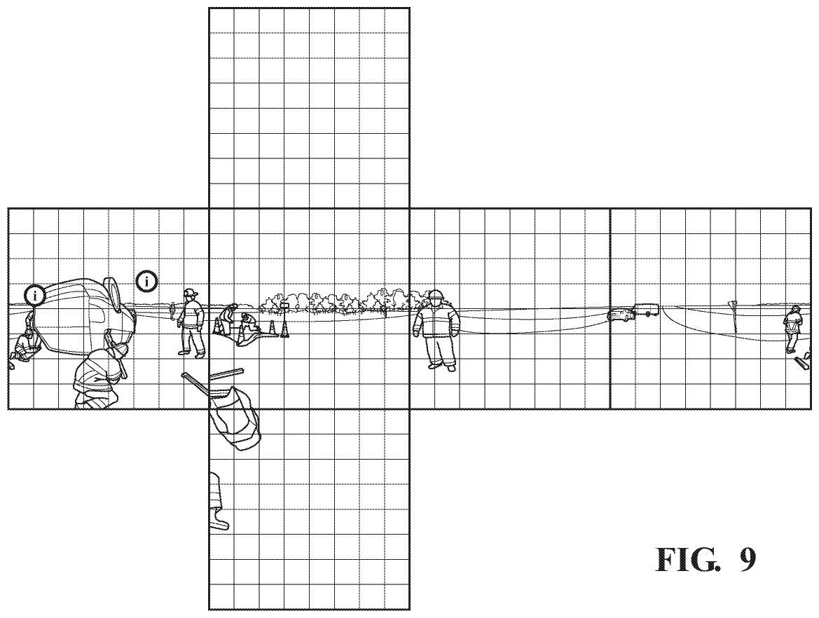

The cube geometry is rendered using a cube map texture layout (1060; FIG. 9), with all interactive elements aligned to their intended positions on the transformed surface, each interactive element corresponding to a spatial orientation within the three-dimensional environment, including front, back, left, right, above, or below relative to a camera or viewing origin. That is, the transition occurs from latitude/longitude coordinates to x, y coordinates on each of the equivalent curvilinear areas on the sphere mapped to each cube face.

The cube map texture layout, may be, for example, unwrapped into a flat image, for example, a horizontal “T” shape image, a vertical “T” shape image, a horizontal cross image or a vertical cross image, etc. In one example, the flat image is unwrapped with the vertical “panning” on the left-hand side and the horizontal “panning” with the central square on the left. The flat image is an image type which can optionally be loaded into a virtual tour software such as, for example only, Pano2VR. The previous format can alternatively or additionally be uploaded to a virtual tour software application. Virtual tour software converts 360-degree imagery into interactive experiences.

In embodiments, the most important subject may be determined along the center of the spherical panorama and set subject to be the center of the spherical image, then with that fixed as the orientation, a cube mapping such as a horizontal “T” as updated in the diagram is performed.

In embodiments, the “cross” or horizontal “T” shape is deconstructed into separate images each of which are renamed with an associated label (e.g., top, bottom, left, right, center, behind). In another example, a virtual tour with ten (10) 360-degree images would have ten (10) horizontal “T” shape images and appropriate labels. The most important subject may be determined along the center of the spherical panorama and set subject to be the center of the spherical image, then with that fixed as the orientation, a cube mapping such as a horizontal “T” as updated in the diagram is performed.

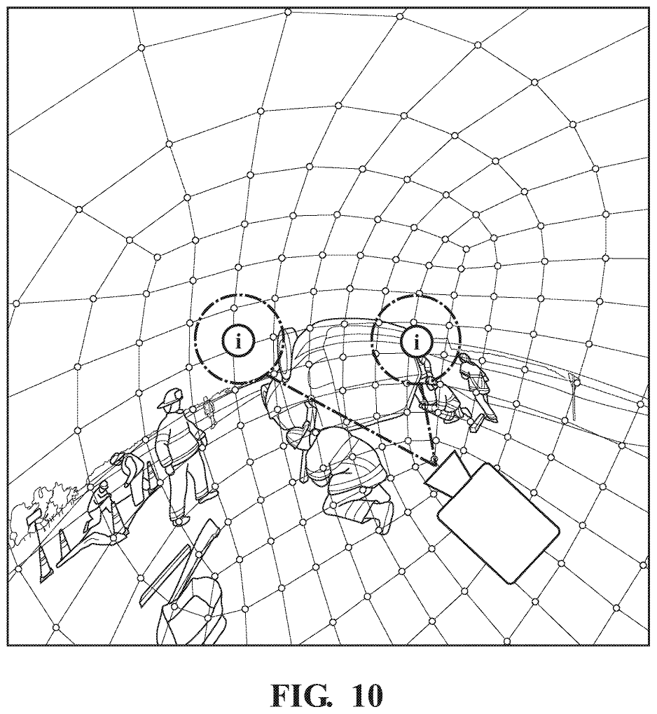

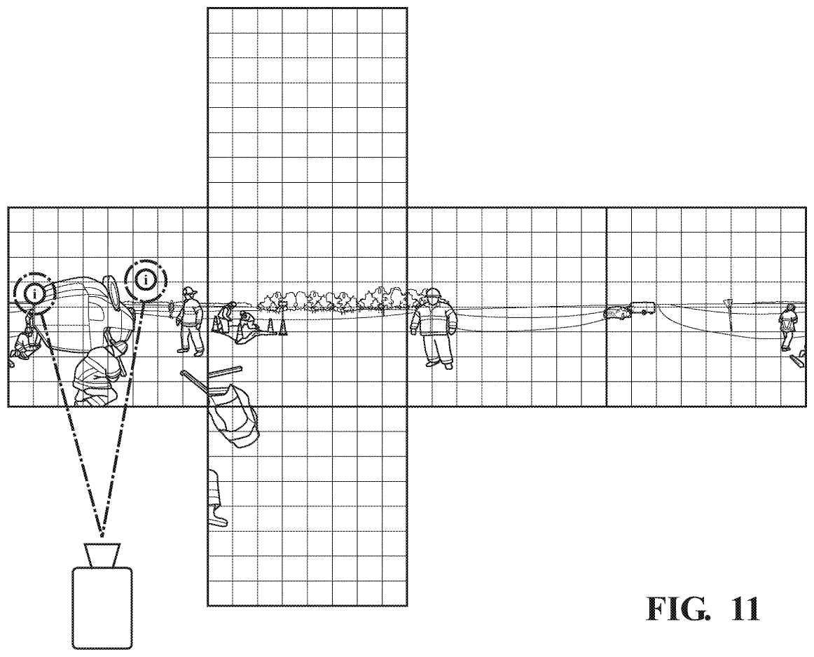

Each hotspot vector (FIG. 10) thereafter corresponds to a spatial orientation within the three-dimensional environment, including front, back, left, right, above, or below relative to the viewer. (1070; FIG. 11). To render such hotspots within the cube map representation, each vector is evaluated to identify a corresponding cube face based on a dominant vector component and is subsequently projected onto the identified face to derive two-dimensional coordinates within that face, thereby preserving spatial orientation across both spherical and cube map representations.

All of the interactive elements on the spherical image are thereby remapped to their corresponding positions on the flattened “T” image which in one embodiment, may involve mapping latitude/longitude coordinates from an equirectangular image to a corresponding flat cube face.

Optionally, or in addition, html elements may be added onto the flat image to render the flat image readable by a visual screen reader. For example, screen readers typically require a fixed orientation to read html elements on a page. When viewed in an interactive viewer, a screen reader has no way of knowing what is left and what is right because on a sphere, one can navigate to any two points with multiple directions of rotation. By flattening the image as the horizontal “T” shape as described above, an image is created that can readily be displayed as a background on a static webpage.

Optionally, or in addition, additional metadata fields of alternate text describing each “face” of the cube may be provided, e.g. “at center is a man wearing a hat”, “at the top you see a blue sky with clouds”, “at the bottom you see the man's feet wearing cowboy boots on a dirt floor”, “to the right you see another man wearing a hat holding a pitchfork”, “behind you is a row of farm tools”, “to your left is a tractor”, etc. The text metadata fields may be incorporated into each of the corresponding images at a fixed orientation so that the screen reader can read such data.

By performing the disclosed method, the interactive experiences can display content in a way that is accessible to screen readers.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

What is claimed is:

1. A method for displaying content accessible to screen readers, comprising:
rendering an equirectangular image onto a surface of the spherical geometry;
creating an immersive visual representation when viewed from the interior of the spherical geometry;
positioning an interactive element on the surface of the spherical geometry based on spherical coordinates corresponding to directional vectors relative to a viewing origin;
transforming the spherical geometry into cube geometry; and
rendering the cube geometry to a cube map texture layout.

2. The method as recited in claim 1, wherein the cube map texture layout is a horizontal cross image.

3. The method as recited in claim 1, wherein transforming the spherical geometry into the cube geometry comprises simultaneously reprojecting the equirectangular texture into a cube map orientation.

4. The method as recited in claim 3, further comprising adding html elements onto each separate image of the cross image.

5. The method as recited in claim 1, wherein rendering the cube geometry to the cube map texture layout comprises rendering the interactive element aligned to an intended positions on the transformed surface, each interactive element corresponding to a spatial orientation within the three-dimensional environment.

6. The method as recited in claim 5, wherein within the three-dimensional environment comprises at least a front, back, left, right, above, and below relative to the viewing origin.

7. The method as recited in claim 1, further comprising generating an output subsequent to the rendering the cube geometry to the cube map texture layout, wherein the output comprising a 2D document object model (DOM)-navigable version of the scene intended for non-visual access.
